(19) United States
(12) Patent Application Publication
(10) Pub. No.: US 2014/0103724 A1
(43) Pub. Date: Apr. 17, 2014

(54) BIDIRECTIONAL POWER SYSTEM, OPERATION METHOD, AND CONTROLLER FOR OPERATING

(71) Applicant: GENERAL ELECTRIC COMPANY, Schenectady, NY (US)

(72) Inventor: Robert Gregory Wagoner, Roanoke, VA (US)

(73) Assignee: GENERAL ELECTRIC COMPANY, Schenectady, NY (US)

(21) Appl. No.: 13/651,499

(22) Filed: Oct. 15, 2012

(51) Int. Cl. H02J 9/00; H02J 3/38

(52) U.S. Cl. 307/44; 307/64; 307/66

(57) ABSTRACT

A power source of a bidirectional power system includes an energy storage device. Power can be transferred between the power source at a DC voltage and an electrical distribution network and/or a load at an AC voltage. A control system monitors for an islanding condition and, during normal operation, maintains an amount of power stored in the energy storage device and provides power to the load and/or network. Responsive to an islanding condition, power to the load can be maintained using the energy storage device, and the power system can be shut down and/or decoupled from the distribution network.

### BACKGROUND OF THE INVENTION

The disclosure relates generally to power systems including power generation and/or storage devices selectively electrically coupled to an electrical distribution network. More particularly, the disclosure relates to operation of a bidirectional power system having an energy storage device, including response to an islanding condition or event.

In some known power systems, particularly power generation systems employing renewable resources, a power generation unit and/or an energy storage device can provide electrical energy and transmit the energy to an electrical grid, a load, and/or another destination. For example, a solar power system may include a plurality of photovoltaic panels (also known as solar panels) logically or physically grouped in one or more arrays of solar panels that convert solar energy into electrical energy. In addition, such a power system may employ one or more wind turbines, hydroelectric power generation arrangements, and/or other power generation devices, energy storage devices, and/or arrangements. In the case of systems including an energy storage device, a common type of energy storage device to employ is a bank of batteries that can store and supply energy in the power system.

Such power generation and/or storage systems typically produce and/or provide direct current (DC) electrical power, but typical destinations require alternating current (AC). A power converter is therefore typically interposed between the power generation devices and the destination of the electrical energy to convert DC electrical energy produced to AC electrical energy suitable for receipt by the destination(s). However, if an electrical distribution network to which the power system is attached experiences an undesirable fluctuation in a voltage and/or a frequency of power carried thereon, damage can occur to one or more components of the power system and/or a load connected to the power system. In addition, if the electrical distribution network stops delivering power to the power system, power to the load may be cut off, which may be undesirable. Either of these and additional conditions can be an islanding condition in response to which the power system can be disconnected from the electrical distribution network.

### BRIEF DESCRIPTION OF THE INVENTION

Embodiments of the invention disclosed herein may take the form of a bidirectional power system including at least one power source configured to provide direct current (DC) power at a first DC voltage and including at least one energy storage device. The energy storage device(s) can be further configured to selectively provide and receive DC power at the first DC voltage. A converter can be coupled to the power source(s) to convert and transfer power between the power source(s) at the first DC voltage and a bus at a second DC voltage that is greater than the first DC voltage. An inverter can be coupled to the bus and configured to convert and transfer power between the bus at the second DC voltage and at least one of an electrical distribution network or a load at a first alternating current (AC) voltage. A control system coupled to the power source(s), the converter, and the inverter can be configured to provide power to the load and to selectively transfer power in a first direction from the power source(s) to the electrical distribution network. In addition, the control system can be configured to selectively transfer power in a second direction from the electrical distribution network to the at least one energy storage device to maintain a determined amount of stored power in the at least one energy storage device.

Embodiments of the invention may also take the form of a method including providing power in a first direction from a power source to an electrical distribution network responsive to an amount of power available from the power source exceeding a demand on the power system. In addition, power can be provided in a second direction from the electrical distribution network to at least one energy storage device of the power source to maintain at least a determined amount of stored power in one or more of the energy storage device(s). Further, the electrical distribution network and/or the power system can be monitored for an islanding condition therein.

Another embodiment can include a controller configured for providing power in a first direction from the power source(s) to the electrical distribution network responsive to an amount of power available from the power source(s) at least equaling a demand on the power system. Power can also be selectively provided from the electrical distribution network in a second direction to the power source(s) to maintain at least a determined amount of stored power in at least one energy storage device of the power source(s). In addition, the control system can monitor at least one of the power system or the electrical distribution network with an islanding detector to detect an islanding condition in at least one of the power system or the electrical distribution network.

Other aspects of the invention provide methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows a schematic diagram of an example of a bidirectional power system that may include embodiments of the invention disclosed herein.

FIG. 2 shows a schematic diagram of another example of a bidirectional power system according to embodiments of the invention disclosed herein.

FIG. 3 shows a schematic flow diagram of an example of a bidirectional power system operation method according to embodiments of the invention disclosed herein.

FIG. 4 shows a schematic block diagram of a computing environment for implementing a bidirectional power system operation method and/or computer program product according to embodiments of the invention disclosed herein.

It is noted that the drawings may not be to scale. The drawings are intended to depict only typical aspects of the invention, and therefore should not be considered as limiting the scope of the invention. In the drawings, like numbering represents like elements between the drawings.

The detailed description explains embodiments of the invention, together with advantages and features, by way of example with reference to the drawings.

### DETAILED DESCRIPTION OF THE INVENTION

As used herein, “start up” means to enable, to engage, to turn on, and/or to start supplying power to a device and/or a component thereof. A “startup sequence” is a series of steps or actions taken to start up a device or component thereof. A startup sequence can be performed in response to a startup event and/or a startup condition. A “startup event” can be a command, a signal, an instruction, a change in an environmental variable, and/or any other occurrence that might indicate that a startup sequence should be performed. Similarly, a “startup condition” can be an environmental state in which a startup sequence should be performed.

In addition, as used herein, “shut down” means to disable, disengage, turn off, and/or stop supplying power to a device and/or a component thereof. A “shutdown sequence” is a series of steps or actions taken to shut down a device or component thereof. A shutdown sequence can be performed in response to a shutdown event or a shutdown condition. A “shutdown event” can be a command, a signal, an instruction, a change in an environmental variable, and/or any other occurrence that might indicate that a device and/or component thereof should be shut down, which can also indicate that a shutdown sequence should be performed. Similarly, a “shutdown condition” can be an environmental state in which a device and/or a component thereof should be shut down, and/or in which a shutdown sequence should be performed.

Further, as used herein, “islanding” refers to a condition or state in which a power system, such as a so-called “micro-grid,” is effectively separated from an electrical distribution network to which the power system is ordinarily connected and with which the power system can ordinarily draw and/or provide power. A micro-grid can be an installation including at least one power source and at least one load that can be powered by the load. While some micro-grids can be standalone installations, many micro-grids can be connected to a larger electrical distribution network. Islanding can be unintentional, where some sort of disruption, failure, or deviation of the electrical distribution network from norms that either cuts power off from the micro-gird or that necessitates disconnection from the network to avoid damage to the micro-grid and/or associated personnel and/or property. Islanding can also be intentional, such as when a cost of power from the network exceeds a cost of production and/or consumption of power from power source(s) of the micro-grid, including energy storage devices, such as batteries or the like as will be described below. Intentional islanding can also be indicated when a predictive technique suggests that an undesirable condition will arise on the network, which approaches the notion of unintentional islanding. An “islanding condition” is a state of a power system and/or electrical distribution network that suggests that islanding has and/or should and/or will occur, and can arise from circumstances related to unintentional islanding and/or from circumstances suggesting that intentional islanding may be desirable.

As described herein, a power system, such as a bidirectional power system, can be selectively connected to an electrical distribution network so as to draw power from the network and/or provide or supply power to the network. The power system can include a power source including at least one battery or other type(s) of energy storage device. The power source can provide direct current (DC) power at a first DC voltage, and any included energy storage device can receive power at the first DC voltage as well as supply power at the first DC voltage. A power converter with a boost converter and an inverter converts the DC power at the first DC voltage into alternating current (AC) power at a first AC voltage and vice versa. The boost converter can be coupled to the power source and the inverter can be coupled to the boost converter, such as by a DC bus, so that the boost converter can convert DC power between the first DC voltage and a second DC voltage, and so that the inverter can convert power between the second DC voltage and the first alternating current (AC) voltage. The inverter can also be coupled to a load and/or the electrical distribution network.

A control system can control operation of the power converter and can be in communication with or include an islanding detector that monitors the power system and/or the electrical distribution network for an islanding condition using any suitable islanding detection technique now known and/or later discovered and/or developed. Absent an islanding condition, the control system can provide power to the load from the electrical distribution network and/or the power source, send excess and/or requested power from the power source to the electrical distribution network, maintain a charge of the storage device(s) of the power source with power from the electrical distribution network and/or another part of the power source, monitor any AC or DC loads on the power system, and can optimize operation of the power system. When an islanding condition is detected, the control system can provide power to any load on the power system by drawing power from the power source, including the energy storage device(s), and can decouple the power system from the electrical distribution network to protect components of the power system.

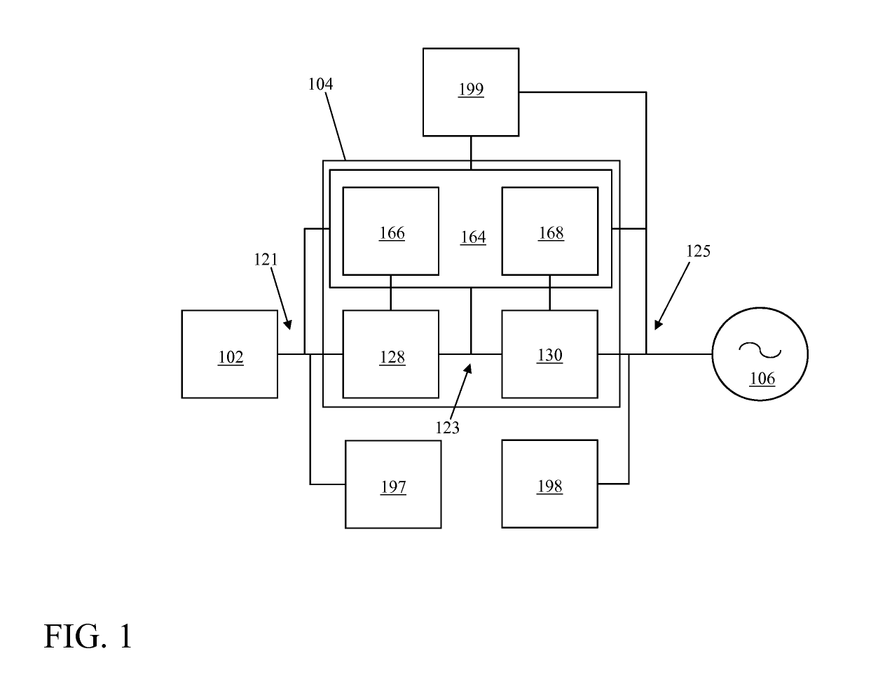

FIG. 1 is a schematic diagram of an exemplary bidirectional power system 100 that can be selectively electrically coupled to an electrical distribution network 106 and that can include at least one power source 102, such as a power generation unit and including at least one energy storage device. Examples of power generation units that can be used in embodiments include solar panels and/or arrays (not shown), wind turbines, fuel cells, geothermal generators, hydropower generators, and/or any other devices that generate and/or produce power from renewable and/or non-renewable energy sources in any suitable number. In addition, examples of energy storage devices that can be used in embodiments include batteries, capacitors, inductors, fuel cells, mechanical potential energy storage devices, such as holding ponds associated with respective hydropower installations and/or spring motors and/or kinetic devices, such as flywheels, associated with respective generators, and/or any other suitable type of energy storage units or devices now known and/or discovered and/or developed in the future in any suitable number. Many types of batteries can be employed as energy storage devices in embodiments, including, but not limited to, sodium nickel halide, lithium air, lithium ion, lithium sulfur, thin film lithium, lithium ion polymer, nickel metal hydride, lithium titanate, alkaline, lithium iron phosphate, nickel cadmium, lead acid, nickel iron, nickel hydrogen, nickel zinc, sodium ion, zinc bromide, vanadium redox, sodium sulfur, silver oxide, molten salt, and/or any other suitable and/or desired type of battery now known and/or as may be developed and/or any combination thereof. Likewise, any suitable fuel cell can be used, including, but not limited to, direct methanol, polymer electrolyte membrane, alkaline, phosphoric acid, molten carbonate, solid oxide, and/or any other suitable and/or desired type of fuel cell now known and/or as may be developed and/or any combination thereof.

In the exemplary embodiment schematically illustrated in FIG. 1, bidirectional power system 100 can include any number of power sources 102 to facilitate operating bidirectional power system 100 at a desired power output. In one embodiment, power source(s) 102 include a plurality of energy storage devices, such as batteries, coupled together in a series-parallel configuration to facilitate providing a desired current and/or voltage output from power system 100 and/or to facilitate storage of power from another of the power source(s) 102, such as a power generation device, and/or electrical distribution network 106. In addition, the at least one power source 102 can be coupled to a power converter or power converter system 104 that can convert power between DC power on a power source side of power converter 104 and AC power on an AC load and/or electrical distribution network side of power converter 104.

When power is supplied by power source(s) 102, power converter 104 can convert provided DC power to AC power that can then be transmitted to electrical distribution network or grid 106 and/or a first AC load 198. Power converter 104 can, in embodiments, adjust an amplitude of the voltage and/or current of AC power to be transmitted to electrical distribution network 106 to a respective amplitude suitable for electrical distribution network 106. In addition, power converter 104 can provide AC power at a frequency and/or a phase substantially equal to a frequency and/or phase extant on electrical distribution network 106. In particular embodiments, power converter 104 can provide three phase AC power to electrical distribution network or grid 106.

When power is supplied by electrical distribution network 106 to energy storage device(s) of power source(s) 102, power converter 104 can convert provided AC power to DC power that can then be transmitted to the energy storage device(s) and/or a first DC load 197. Power converter 104 can, in embodiments, adjust an amplitude of the voltage and/or current of DC power to be transmitted to the energy storage device(s) and/or first DC load 197 to a respective suitable amplitude.

A boost converter 128 of power converter 104 can be selectively electrically coupled to power source(s) 102 in embodiments, as can a DC load 197. Power converter 104 can also include an inverter 130 selectively electrically coupled to boost converter 128 and/or to electrical distribution network 106 and/or a first AC load 198. Boost converter 128 can be configured to transfer and convert power between power source(s) 102 at a first DC voltage and inverter 130 at a second DC voltage that is higher or greater than the first DC voltage. Inverter 130 can be configured to transfer and convert power between boost converter 128 at the second DC voltage and electrical distribution network 106 and/or first AC load 198 at a first AC voltage. For example, in the U.S. and other countries with similar power standards, first DC voltage can be about 12V and first AC voltage can be one of about 120V or about 220V. In addition, power at the first AC voltage can have a frequency of about 60 Hz and one of a single phase at 120V or three phases at 220V. As should be clear, these voltages are examples, and actual voltages may occupy a ranged. For example, first AC voltage can be from about 110 VAC to about 130 VAC or from about 200 VAC to about 240 VAC. In addition, other values can be used for these voltages and, for AC power, associated frequencies and/or phases as may be desired and/or suitable and/or appropriate. In countries employing 230 VAC/50 Hz power, for example, first AC voltage can be from about 200 VAC to about 250 VAC at 50 Hz, and can particularly be about 220 VAC. Further, any suitable second DC voltage can be used, such as, for example, 400V DC, depending on first DC voltage, first AC voltage, and other factors as would be known one skilled in the art.

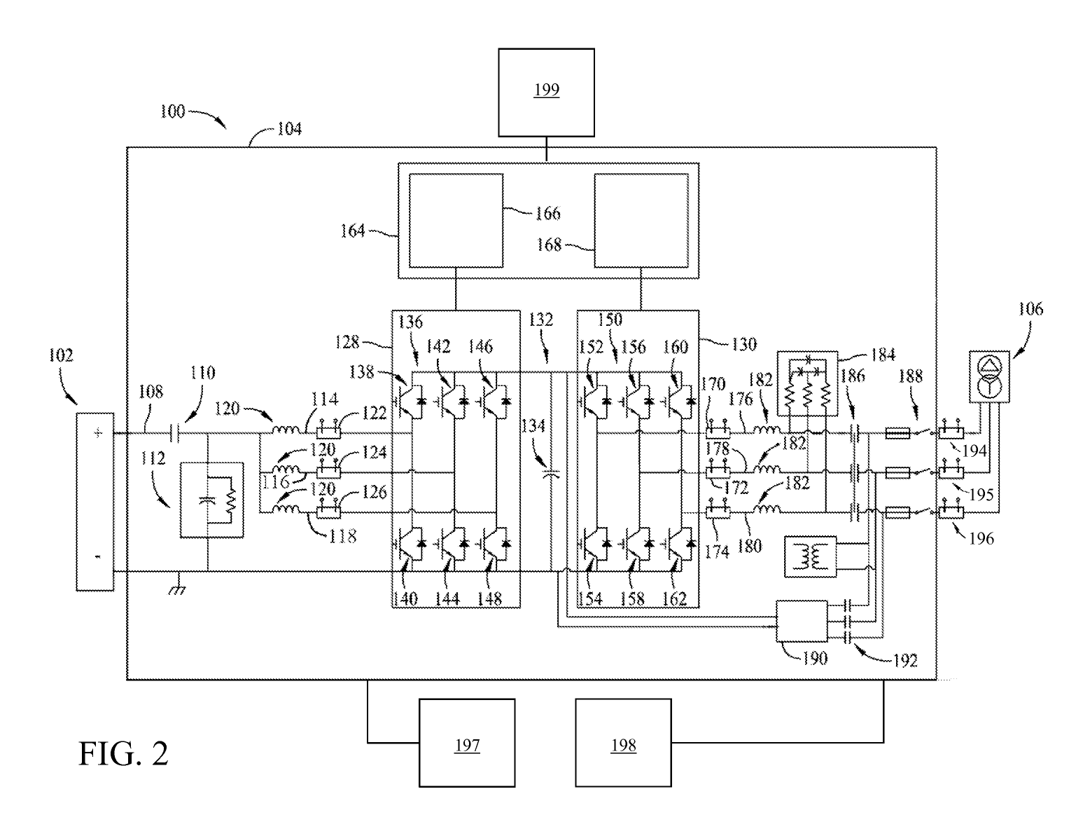

A control system 164 of converter 104 shown in FIG. 1 can monitor power system 100, such as by monitoring DC voltage at a first point 121 and/or a second point 123, by monitoring AC voltage at a third point 125, and/or by monitoring any DC load 197 and/or AC load 198 that might be coupled to power system 100. Control system 164 can also monitor electrical distribution network 106, such as by measuring AC voltage, frequency, and/or phase at third point 125. In addition, control system 164 can include or be in communication with an islanding detector 199 that can send a signal to control system 164 when an islanding condition is detected. As indicated above, any suitable islanding detection technique can be employed, such as monitoring a parameter of electrical distribution network 106 at third point 125 as seen in FIG. 1 and/or by using current and/or other sensors 194, 195, 196 as seen in FIG. 2. In embodiments, control system 164 can monitor electrical distribution network 106 using islanding detector 199.

Control system 164 can use a boost converter controller 166 and/or an inverter controller 168 responsive to the monitoring of power system 100 and/or electrical distribution network 106 to control boost converter 128 and/or inverter 130, respectively, in embodiments. For example, control system 164 can selectively provide bidirectional power flow between power source(s) 102 and electrical distribution network 106 so that excess power produced in power system 100 can be supplied or provided to electrical distribution network 106 and/or so that an amount of stored power of any energy storage device(s) of power source(s) 102 can be maintained by drawing power from electrical distribution network 106 and/or another power source 102. In addition, control system 164 can adjust operation of power system 100 in the event that a connection status of any DC load 197 and/or any AC load 198 changes. However, responsive to detection of an islanding condition by islanding detector 199, control system 164 can control power converter 104 and/or power source(s) 102 to provide power demanded by any DC load 197 and/or any AC load 198. In embodiments, power is provided during islanding only as long as it may take to shut down power system 100, while in other embodiments, power can be provided as long as demand is present and power source(s) 102 can provide power to meet demand. To protect power system 100 against undesirable surges and/or fluctuations during and/or after islanding, control system 164 can decouple power system 100 from electrical distribution network, as will be described below.

A more detailed example of a power system 100 according to embodiments is shown schematically in FIG. 2, in which DC power can be transferred between power source(s) 102 and power converter 104 through a converter conductor 108 in electrical communication with power converter 104 and power source(s) 102. It should be understood that since power system 100 is bidirectional in embodiments, components referred to as “input” components and/or as “receiving” power can also be “output” components and/or “provide” and/or “supply” and/or “send” power depending on in which direction power flows through power system 100. Likewise, components referred to as “output” components and/or “providing” and/or “supplying” and/or “sending” power can also be “input” components and/or “receive” power depending on in which direction power flows through power system 100.

Turning again to FIG. 2, protection device 110 can electrically disconnect power source(s) 102 from power converter 104, for example, if an error or a fault occurs within power system 100. As used herein, the terms “disconnect” and “decouple” are used interchangeably, and the terms “connect” and “couple” are used interchangeably. Protection device 110 in embodiments can be a current protection device, such as a circuit breaker, a fuse, a contactor, and/or any other device that enables power source(s) 102 to be controllable disconnected from power converter 104. A DC filter 112 can be coupled to converter conductor for use in filtering an input voltage and/or current received from and/or sent to power source(s) 102.

Converter conductor 108, in the exemplary embodiment, can be coupled to a first input conductor 114, a second input conductor 116, and/or a third input conductor 118 such that the input current can be split between first, second, and/or third input conductors 114, 116, 118. Alternatively, the input current can be conducted to a single conductor, such as converter conductor 108, and/or to any other number of conductors that can enable power system 100 to function as described herein and/or as desired. At least one boost inductor 120 can be coupled to each of first input conductor 114, second input conductor 116, and/or third input conductor 118. Each boost inductor 120 can facilitate filtering input voltage and/or current received from power source(s) 102. In addition, at least a portion of energy received from power source(s) 102 can be temporarily stored within each boost inductor 120. A first input current sensor 122 can be coupled to first input conductor 114, a second input current sensor 124 can be coupled to second input conductor 116, and/or a third input current sensor 126 can be coupled to third input conductor 118 so as to measure current flowing through a respective input conductor 114, 116, 118.

In the exemplary embodiment, power converter 104 can include a DC to DC or boost converter 128 and an inverter 130 coupled together by a DC bus 132. Boost converter 128 can be coupled to and receive DC power from power source(s) 102 through first, second, and/or third input conductors 114, 116, 118. In addition, boost converter 128 can adjust voltage and/or current amplitude of DC power received from power source(s) 102. In the exemplary embodiment, inverter 130 can be a DC-AC inverter that converts DC power received from boost converter 128 to AC power suitable for transmission to electrical distribution network 106. Moreover, in the exemplary embodiment, DC bus 132 can include at least one energy storage device 134, such as at least one capacitor and/or at least one of any other electrical energy storage device that can enable power convert 104 to function as described herein and/or as may be desired. As current is transmitted through power converter 104, a voltage can be generated across DC bus 132 and energy can be stored within energy storage device 134.

Boost converter 128, in the exemplary embodiment, can include two converter switches 136 coupled together in serial arrangement for each phase of electrical power that power converter 104 can produce. Converter switches 136 can be insulated gate bipolar transistors (IGBTs) in embodiments, though any other suitable transistor and/or switching device can be used. In addition, each pair of converter switches 136 for each respective phase can be coupled in parallel with any other pairs of converter switches 136 for any other respective phases. For example, where power converter 104 produces three phases, boost converter 128 can include a first converter switch 138 coupled in series with a second converter switch 140, a third converter switch 142 coupled in series with a fourth converter switch 144, and a fifth converter switch 146 coupled in series with a sixth converter switch 148. For such a three phase power converter 104, first and second converter switches 138, 140 are coupled in parallel with third and four converter switches 142, 144, and with fifth and sixth converter switches 146, 148. Alternatively, boost converter 128 can include any suitable number of converter switches 136 arranged in any suitable configuration.

Inverter 130, in the exemplary embodiment, can include two inverter switches 150 coupled together in serial arrangement for each phase of electrical power that can be produced by power converter 104. Each inverter switch 150 can be an IGBT and/or any other suitable transistor and/or any other suitable switching device in embodiments. In similar fashion to boost converter 138, each pair of inverter switches for each respective phase can be coupled in parallel with any other pairs of inverter switches 150 for any other respective phases. For example, where inverter 130 produces three phases, inverter 130 can include a first inverter switch 152 coupled in series with a second inverter switch 154, a third inverter switch 156 coupled in series with a fourth inverter switch 158, and a fifth inverter switch 160 coupled in series with a sixth inverter switch 162. For such a three phase power converter 104, first and second inverter switches 152, 154 can be coupled in parallel with third and four inverter switches 156, 158, and with fifth and sixth inverter switches 160, 162. Alternatively, inverter 130 can include any suitable number of inverter switches 150 arranged in any suitable configuration.

With continued reference to FIG. 2, power converter 104 can include a control system 164 that can include a converter controller 166 and/or and inverter controller 168. Converter controller 166 can be coupled to and control operation of boost converter 128. In embodiments, converter controller 166 can operate boost converter 128 so as to maximize power received from power source(s) 102. Likewise, inverter controller 168 can be coupled to and control inverter 130. In embodiments, inverter controller 168 can operate inverter 130 so as to regulate voltage across DC bus 132 and/or to adjust voltage, current, phase, frequency, and/or any other characteristic of power output from inverter 130 to substantially match a corresponding characteristic extant in electrical distribution network 106.

Control system 164, converter controller 166, and/or inverter controller 168 in embodiments can include and/or can be implemented by at least one computing device and/or at least one processor. As used herein, each computing device and/or processor can include and suitable programmable circuit such as, for example, one or more systems and microcontrollers, microprocessors, reduced instruction set circuits (RISCs), complex instruction set circuits (CISCs), application specific integrated circuits (ASICs), programmable logic circuits (PLCs), field programmable gate arrays (FPGAs), and/or any other circuit capable of executing the functions described herein and/or as desired. The above examples are not intended to limit in any way the definition and/or meaning of the terms “processor” and/or “computing device.” In addition, control system 164, converter controller 166, and/or inverter controller 168 can include at least one memory device (not shown) that can store computer-executable instructions and/or data, such as operating data, parameters, setpoints, threshold values, and/or any other data that can enable control system 164 to function as described herein and/or as desired.

Converter controller 166 in embodiments can receive current measurement(s) from first input current sensor 122, second input current sensor 124, and/or third input current sensor 126. In addition, converter controller 166 can received measurement(s) of voltage of first input conductor 114, second input conductor 116, and/or third input conductor 118 from one or more respective voltage sensors (not shown). Likewise, inverter controller 168 in embodiments can receive current measurement(s) from a first output current sensor 170, a second output current sensor 172, and/or a third output current sensor 174. Further, inverter controller 168 can receive measurement(s) of a voltage output from inverter 130 from at least one output voltage sensor (not shown). In embodiments, converter controller 166 and/or inverter controller 168 can additionally receive voltage measurement(s) of the voltage across DC bus 132 from at least one DC bus voltage sensor (not shown).

In the exemplary embodiment shown in FIG. 2, inverter 130 can be coupled to electrical distribution network or grid 106 by a first output conductor 176, a second output conductor 178, and/or a third output conductor 180. Inverter 130 can thus provide a first phase of AC power to electrical distribution network or grid 106 through first output conductor 176, a second phase of AC power to electrical distribution network or grid 106 through second output conductor 178, and/or a third phase of AC power to electrical distribution network or grid 106 through third output conductor 180. First output current sensor 170 can be coupled to first output conductor 176 so as to measure current flowing therethrough. Similarly, second output current sensor 172 can be coupled to second output conductor 178 so as to measure current flowing therethrough, and/or third output current sensor 174 can be coupled to third output conductor 180 so as to measure current flowing therethrough. At least one inductor 182 can be coupled to each of first output conductor 176, second output conductor 178, and/or third output conductor 180. Each inductor 182 can facilitate filtering output voltage and/or current received from 130. In addition, an AC filter 184 can be coupled to first output conductor 176, second output conductor 178, and/or third output conductor 180 to enable filtering an output voltage and/or current received from first, second, and third output conductors 176, 178, 180.

In the exemplary embodiment, at least one contactor 186 and/or at least one disconnect switch 188 are coupled to first output conductor 176, second output conductor 178, and/or third output conductor 180. Contactors 186 and disconnect switches 188 electrically disconnect inverter 130 from electrical distribution network 106, for example, if an error or a fault occurs within power system 100. Moreover, in the exemplary embodiment, protection device 110, contactors 186 and disconnect switches 188 are controlled by control system 164. Alternatively, protection device 110, contactors 186 and/or disconnect switches 188 are controlled by any other system that enables power converter 104 to function as described herein.

Power converter 104 can also include a bus charger 190 that is coupled to first output conductor 176, second output conductor 178, third output conductor 180, and to DC bus 132. In the exemplary embodiment, at least one charger contactor 192 is coupled to bus charger 190 for use in electrically disconnecting bus charger 190 from first output conductor 176, second output conductor 178, and/or third output conductor 180. Moreover, in the exemplary embodiment, bus charger 190 and/or charger contactors 192 are controlled by control system 164 for use in charging DC bus 132 to a determined voltage.

Control system 164 in embodiments can receive measurements from current and other sensors in power system 100 and additionally can receive measurement(s) of current and/or other properties in/of electrical distribution network 106 through current sensors 194, 195, 196 (shown) and/or other appropriate sensors as may be suitable and/or desired. In embodiments, islanding detector 199 can receive measurement(s) from sensors of properties of electrical distribution network, such as current from sensors 194, 195, 196, and can pass such measurements on to control system 164. Alternatively, islanding detector 199 can simply provide a signal indicative of an islanding condition responsive to measurement(s) received by islanding detector 199.

During operation in a first power flow direction, in the exemplary embodiment, power source(s) 102 can generate DC power and transmit the DC power to boost converter 128. Converter controller 166 can control a switching of converter switches 136 to adjust an output of boost converter 128. More specifically, in the exemplary embodiment, converter controller 166 can control the switching of converter switches 136 to adjust the voltage and/or current received from power source(s) 102 such that the power received from power source(s) 102 is increased and/or maximized. Power on a power source side of boost converter 128 can have first DC voltage as described above, which boost converter 128 can adjust to second DC voltage. Converter controller 166 can use any suitable control algorithm, such as pulse width modulation (PWM) and/or any other control algorithm in the control of converter switch(es) 136.

Inverter controller 168, in the exemplary embodiment, can control a switching of inverter switches 150 to adjust an output of inverter 130. More specifically, in the exemplary embodiment, inverter controller 168 can use a suitable control algorithm, such as PWM and/or any other control algorithm, to transform the DC power received from boost converter 128 at second DC voltage into power at the first AC voltage and that can include three phase AC power signals. Alternatively, inverter controller 168 can cause inverter 130 to transform the DC power into a single phase AC power signal at first AC voltage or any other signal and/or AC voltage that enables power converter 104 to function as described herein. Power thus converted by inverter 130 can then be supplied to electrical distribution network 106 and/or any AC load 198 that might be connected to bidirectional power system 100.

In an exemplary embodiment, each phase of the AC power can be filtered before transmission to electrical distribution network 106 and/or load 198 by AC filter 184. Where inverter 130 provides three phase AC power, the filtered three phase AC power can then be transmitted to electrical distribution network 106. In the exemplary embodiment, three phase AC power can also be transmitted from electrical distribution network 106 to DC bus 132 by bus charger 190. In one embodiment, bus charger 190 can use the AC power to charge DC bus 132 to a suitable voltage amplitude, for example, during a startup and/or a shutdown sequence of power converter 104.

When power flows in a second direction, inverter controller 168, in the exemplary embodiment, can control a switching of inverter switches 150 to receive and adjust power from electrical distribution network 106 and/or adjust an output of inverter 130 to bus 132. More specifically, in the exemplary embodiment, inverter controller 168 can use a suitable control algorithm, such as PWM and/or any other control algorithm, to transform power received at the first AC voltage at one or three phase AC power signals into DC power to send to boost converter 128 at second DC voltage.

Additionally, when power flows in the second direction, converter controller 166 can control a switching of converter switches 136 of boost converter 128 to adjust power received from inverter 130 for receipt by energy storage device(s) of power source(s) 102 and/or any DC load 197 that might be connected to bidirectional power system 106. More specifically, in the exemplary embodiment, converter controller 166 can control the switching of converter switches 136 to adjust the voltage and/or current received from inverter 130 and/or bus 132 at the second DC voltage such that the power second DC voltage on an inverter side of boost converter 130 can be reduced to first DC voltage on the power source side of boost converter 128.

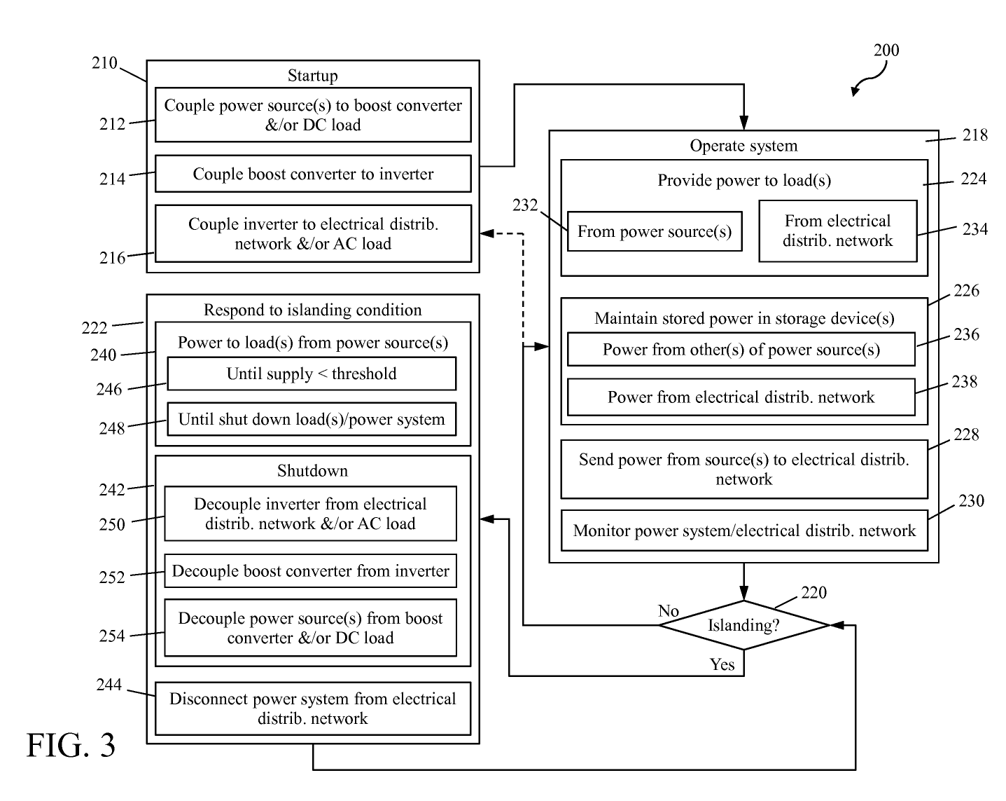

FIG. 3 is a schematic diagram of an exemplary method 200 of operating power system 100 (shown in FIG. 1). In the exemplary embodiment, method 200 is implemented by control system 164, including converter controller 166 and/or inverter controller 168 and/or islanding detector 199 (all shown in FIG. 1). Alternatively, method 200 may be implemented by any other system that enables power system 100 to function as described herein and/or as may be desired and/or suitable.

In the exemplary embodiment, before method 200 is executed, the duty cycles of converter switches 136 and inverter switches 150 can be equal to about zero and protection device 110 can be open such that power source(s) 102 is electrically decoupled from boost converter 128. Thus, the state of power system 100 can be a shutdown state, in which no current and/or power is delivered from power source(s) 102 to electrical distribution network 106 or vice versa.

Broadly, when method 200 is executed, a startup routine (block 210) can be performed where converter 104 is in a shutdown state. With converter 104 running, power system 100 can be operated (block 218), and a check for and/or detection of an islanding condition (block 220) can be performed, such as by using islanding detector 199. If an islanding condition is not detected at block 220, operation can continue (return to block 218). However, if an islanding condition is detected at block 220, then a response to the islanding condition can be performed (block 222), such as by control system 164, as will be described in more detail below.

Startup (block 210) can include, for example, closing protection device 110 to electrically couple power source(s) 102 to boost converter 128 and/or DC load 197 (block 212), and coupling boost converter 128 to inverter 130 (block 214), such as by adjusting a duty cycle of converter switches 136 with converter controller 166. In addition, inverter 130 can be electrically coupled to electrical distribution network 106 and/or first AC load 198 (block 216), such as by adjusting a duty cycle of inverter switches 150 with inverter controller 168 and/or closing one or more of switches 188 with control system 164.

Control system 164 can operate power system 100 (block 218) to provide power to any load(s) 197, 198 on power system 100 (block 224), such as from power source(s) 102 (block 232) in the first direction and/or from electrical distribution network 106 (block 234) in the second direction. Operation can also include maintaining an amount of stored power in storage power device(s) of power source(s) 102 (block 226), such as by using power from one or more other of power source(s) 102 (block 236) and/or by using power from electrical distribution network 106 (block 238). For example, if power source(s) include a battery bank and a wind turbine, power from the wind turbine could be used to add power to the battery bank, and/or power from electrical distribution network 106 could be used. In addition, control system 164 can send power from power source(s) 102 to electrical distribution network 106 (block 228), and/or monitor power system 100 and/or electrical distribution network 106 (block 230). For example, current and/or voltage sensors and/or other sensors as described above and as may be desired and/or suitable can be used to measure properties of various points in power system 100 and/or electrical power distribution system 106, and control system 164 can monitor power system 100 using such measurements. The check and/or determination and/or detection of an islanding condition (block 220) can be performed using results of monitoring (block 230), such as by using islanding detector 199, though in embodiments, the check can be construed as part of monitoring (block 230). If no islanding condition is detected, operation can continue (return to block 218).

Control system 164 can effect flow of power in the first direction from power source(s) 102 to load(s) 197, 198 and/or electrical distribution network 106 by, for example, adjusting duty cycles of converter switches 136 and inverter switches 150, such as with converter controller 166 and/or inverter controller 168, in a first manner. Similarly, control system 164 can effect flow of power in the second direction from electrical distribution network 106 to power source(s) 102 by, for example, adjusting duty cycles of converter switches 136 and inverter switches 150, such as with converter controller 166 and/or inverter controller 168, in a second manner.

As indicated above, control system 164 can provide power to any load(s) on power system 100 from power source(s) 102 (block 232) and/or from electrical distribution network 106 (block 234). The particular manner in which this is performed can depend on whether electrical distribution network 106 is a primary power supply or whether power source(s) 102 are a primary power supply. Where electrical distribution network 106 is primary, for example, control system 164 can maintain stored power (block 226) with power source(s) 102 (block 236) and/or electrical distribution network 106 (block 238), but need not direct power from power source(s) 102 to the load(s) (block 232) unless some kind of failure occurs in electrical distribution network 106, which would likely give rise to an islanding condition. In such an embodiment, control system 164 could also send power to electrical distribution network 106 when the energy storage device(s) have a sufficient amount of stored power. Sending power to electrical distribution network 106 in this manner allows an operator and/or owner of power system 100 to sell the power to an operator and/or owner of electrical distribution network 106, though power could be sold to another entity also connected to electrical distribution network 106, such as a power delivery company and/or a consumer. Control system 164 can also direct power from power source(s) 102 to load(s) 197, 198 in the event of a failure or disconnection from electrical distribution network 106, such as might give rise to an islanding condition.

If power source(s) 102 are a primary supply, then load(s) 197, 198 can be supplied from power source(s) 102 (block 232) unless power available from power source(s) 102 is not sufficient to meet a demand on power system 100, including demand of load(s) 197, 198. Power can be provided from electrical distribution network 106 (block 234) to supplement supply from power source(s) 102 to meet such demand. In addition, if power from electrical distribution network 106 is available at a cost lower than a cost of power from power source(s) 102, it may be desirable to power any load(s) on power system 100 completely with power from electrical distribution network 106. However, when power source(s) 102 produce or have available more power than is required by demand on power system 100, excess power can be sent to electrical distribution network 106 (block 228). For example, excess power might be produced if power source(s) 102 include a wind turbine and wind is strong and/or demand is low. Similarly, excess power might be produced if power source(s) 102 include a solar array and skies are clear during the day and/or demand is low, and/or if power source(s) 102 include a hydroelectric generator, water flow is strong and/or demand is low. The power source in question can also be a combustion based generator, such as may rely on fossil fuels and/or biofuels, and/or any other type of power generator. As suggested above, sending excess power in this manner allows an operator and/or owner of power system 100 to sell the excess power to an operator and/or owner of electrical distribution network 106, though power could be sold to another entity also connected to electrical distribution network 106, such as a power delivery company and/or a consumer. Also as suggested above, power flowing from power source(s) 102 to any load(s) and/or electrical distribution network 106 can be considered to flow in a first direction, while power flowing from electrical distribution network 106 into power system 100, and/or to power source(s) 102, can be considered to flow in a second direction.

A response to an islanding condition (block 222) existing and/or being detected in power system 100 and/or electrical distribution network 106 (“Yes” in block 220), can include powering any load(s) 197, 198, such as by drawing power from power source(s) 102 responsive to the demand on power system 100. In embodiments, power can be provided to load(s) 197, 198 as long as power is available from power source(s) 102, which in embodiments can be determined as supply from power source(s) exceeding a threshold minimum power available (block 246). In addition, control system 164 can in embodiments maintain power to load(s) 197, 198 until the load(s) and/or power system 100 and/or converter 104 can be shut down (block 248). Shutdown (block 242) can include, for example, decoupling inverter 130 from electrical distribution network 106 and/or AC load 198 (block 250), decoupling boost converter 128 can be decoupled from inverter 130 (block 252), and/or decoupling boost converter 128 from power source(s) 102 and/ (block 250) or inverter 130 (block 254). In addition, power system 100 can be decoupled and/or disconnected from electrical distribution network 106 (block 244), such as to protect components of power system 100 against damage responsive to the islanding condition. In embodiments, control system 164 can check whether the islanding condition still exists (block 220) and can initiate startup (block 210) and/or normal operation (block 218) once the islanding condition has been eliminated.

As discussed above, islanding detector 199 and/or control system 164 can employ any suitable technique do detect and/or determine that an islanding condition exists. Islanding can result from an interruption or disruption of power supplied by electrical distribution network 106, or can result from a determination by control system 164 that power system 100 should be disconnected from electrical distribution network 106 for other reasons. Interruption and/or disruption of distribution network power supply can be detected passively and/or actively, and in some cases islanding can be predicted before power from the network degrades beyond a threshold level.

Passive islanding detection techniques typically measure a characteristic of power system 100 and/or electrical distribution network 106 and determine that an islanding condition occurs when the characteristic of the electrical distribution network reaches a threshold level. For example, a voltage and/or a frequency and/or voltage phase angle of power from electrical distribution network 106 can be monitored to detect under/over voltage, under/over frequency, and/or voltage phase jumping. Another passive detection method monitors total harmonic distortion (THD) of power system 100 or a subset thereof. If electrical distribution network 106 suffers a failure, then the THD of power system 100 will tend to match that of inverter 130 and become measurable.

Active islanding detection techniques can detect and/or predict failure of electrical distribution network 106 by introducing small signals into the network and determining whether the signal changes after introduction. For example, an overall impedance of power system 100 can be measured by boosting current amplitude, which results in a noticeable change in voltage, which can indicate that an islanding condition exists. A variation of this technique, impedance measurement at a specific frequency, introduces harmonics at a specific frequency, the response to which is not measurable unless the network has failed. Another active technique is slip mode frequency shifting, in which the inverter is caused to misalign the frequency of its output with the network. Ordinarily, the network would overwhelm this misalignment, but in the event of a network failure, the inverter output frequency drifts farther and farther from design frequency, which can be used to indicate that an islanding condition is extant. Yet another active technique is known as frequency bias and also introduces a slightly off frequency signal, but corrects the frequency at the end of each cycle, resulting in a signal similar to that of slip mode frequency shifting that is easily detected in the event of network failure. It should be noted that the above examples are based in and/or on sensing and/or actions by control system 164 of power system 100. However, islanding can also be detected by an operator of the network. For example, the transfer trip method can use network fault detection hardware and/or methods to determine that an islanding condition has occurred. Another network operator technique is impedance insertion, in which the network operator forces a section of the network to force disconnection from the network,

As suggested above, shutdown of power system 100 or a component thereof may be desirable under certain circumstances. To determine whether shutdown should be initiated, factors such as load priority, power available, demand, cost, and/or other factors as may be desirable and/or appropriate may be considered. For example, if power system 100 represents a hospital and power source(s) include at least one combustion-based generator and/or an energy storage device, it is likely that loads within the hospital will have very high priority since lives and/or wellbeing of patients may depend on an uninterrupted supply of power. For such high priority loads, shutdown would be delayed as long as possible, such as when power available falls below a threshold level, such as a fuel level of the generator(s) and/or an amount of energy remaining in the energy storage device(s). At an opposite extreme, at least to many people, if power system 100 represents a home with a generator as a power source and a gaming system as the only load, shutdown is more likely to be indicated since gaming is likely to have a low priority. Power can be maintained to the gaming system until shutdown, which can be delayed if the gaming system requires time to save data and/or shut down itself. As should be clear, assignment of priority can be a subjective endeavor, though it is likely that most would assign a higher priority to loads related to life support and/or “essential” comforts, such as refrigeration, heating/cooling, communications, and/or life-sustaining devices. As should also be clear, many other criteria can be considered in the determination of whether and/or when power system 100 and/or a component thereof should be shut down.

A technical effect of the systems and methods described herein includes selectively providing, in a bidirectional power system, power flow between an energy storage device of a power source and an electrical distribution network to maintain a charge of the energy storage device and/or power a load on the power system and/or deliver power to the electrical distribution network. An additional technical effect is to manage a power converter so as to convert power between a first DC voltage of the power source and a first AC voltage of the electrical distribution network to facilitate the selective provision of bidirectional power flow, which can include convert power between the first DC voltage and a second DC voltage with a boost converter, and to convert power between the second DC voltage and the first AC voltage with an inverter. A further technical effect is to monitor for an islanding condition and, responsive to an islanding condition, maintain power to a load on the power system using power from the power source and/or disconnect or decouple the power system from the electrical distribution network and/or shut down one or more components of the power system.

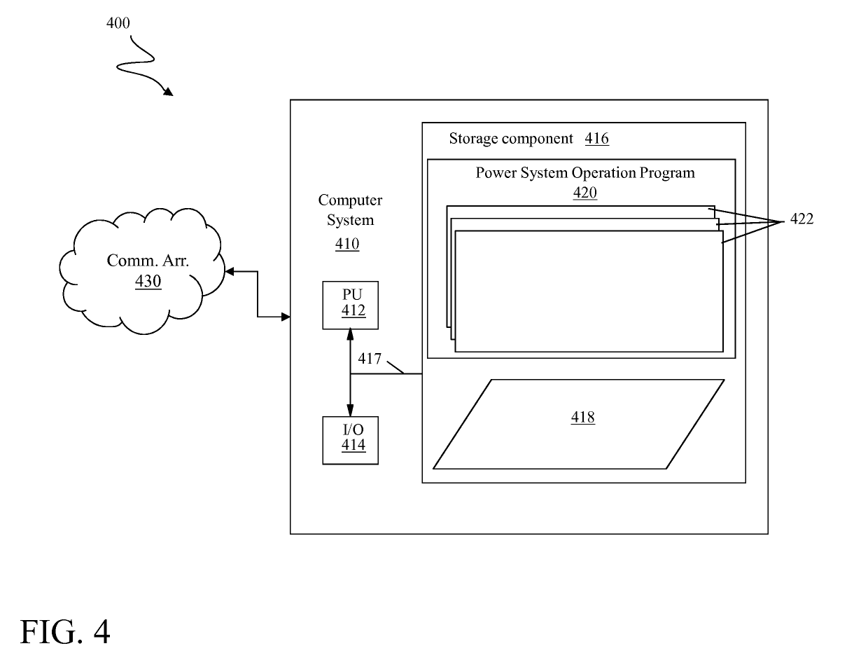

Turning to FIG. 4, an illustrative environment 400 for a power system operation computer program product is schematically illustrated according to an embodiment of the invention. To this extent, environment 400 includes a computer system 410, such as control system 164, converter controller 166, and/or inverter controller 168, and/or other computing device that can be part of a power system that can perform a process described herein in order to execute a power system operation method according to embodiments. In particular, computer system 410 is shown including a power system operation program 420, which makes computer system 410 operable to manage data in a power system operation control system or controller by performing a process described herein, such as an embodiment of the power system operation method 200 discussed above.

Computer system 410 is shown including a processing component or unit (PU) 412 (e.g., one or more processors), an input/output (I/O) component 414 (e.g., one or more I/O interfaces and/or devices), a storage component 416 (e.g., a storage hierarchy), and a communications pathway 417. In general, processing component 412 executes program code, such as power system operation program 420, which is at least partially fixed in storage component 416, which can include one or more non-transitory computer readable storage medium or device. While executing program code, processing component 412 can process data, which can result in reading and/or writing transformed data from/to storage component 416 and/or I/O component 414 for further processing. Pathway 417 provides a communications link between each of the components in computer system 410. I/O component 414 can comprise one or more human I/O devices, which enable a human user to interact with computer system 410 and/or one or more communications devices to enable a system user to communicate with computer system 410 using any type of communications link. In addition, I/O component 414 can include one or more sensors, such as voltage, frequency, and/or current sensors as discussed above. In embodiments, a communications arrangement 430, such as networking hardware/software, enables computing device 410 to communicate with other devices in and outside of a power system and/or power system component in which it is installed. To this extent, power system operation program 420 can manage a set of interfaces (e.g., graphical user interface(s), application program interface, and/or the like) that enable human and/or system users to interact with power system operation program 420. Further, power system operation program 420 can manage (e.g., store, retrieve, create, manipulate, organize, present, etc.) data, such as power system operation data 418, using any solution. In embodiments, data can be received from one or more sensors, such as voltage, frequency, and/or current sensors as discussed above.

Computer system 410 can comprise one or more general purpose computing articles of manufacture (e.g., computing devices) capable of executing program code, such as power system operation program 420, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. Additionally, computer code can include object code, source code, and/or executable code, and can form part of a computer program product when on at least one computer readable medium. It is understood that the term “computer readable medium” can comprise one or more of any type of tangible, non-transitory medium of expression, now known or later developed, from which a copy of the program code can be perceived, reproduced, and/or otherwise communicated by a computing device. For example, the computer readable medium can comprise: one or more portable storage articles of manufacture, including storage devices; one or more memory/storage components of a computing device; paper; and/or the like. Examples of memory/storage components and/or storage devices include magnetic media (floppy diskettes, hard disc drives, tape, etc.), optical media (compact discs, digital versatile/video discs, magneto-optical discs, etc.), random access memory (RAM), read only memory (ROM), flash ROM, erasable programmable read only memory (EPROM), or any other tangible, non-transitory computer readable storage medium now known and/or later developed and/or discovered on which the computer program code is stored and with which the computer program code can be loaded into and executed by a computer. When the computer executes the computer program code, it becomes an apparatus for practicing the invention, and on a general purpose microprocessor, specific logic circuits are created by configuration of the microprocessor with computer code segments.

The computer program code can be written in computer instructions executable by the controller or computing device, such as in the form of software encoded in any programming language. Examples of suitable computer instruction and/or programming languages include, but are not limited to, assembly language, Verilog, Verilog HDL (Verilog Hardware Description Language), Very High Speed IC Hardware Description Language (VHSIC HDL or VHDL), FORTRAN (Formula Translation), C, C++, C#, Java, ALGOL (Algorithmic Language), BASIC (Beginner All-Purpose Symbolic Instruction Code), APL (A Programming Language), ActiveX, Python, Perl, php, Tcl (Tool Command Language), HTML (HyperText Markup Language), XML (eXtensible Markup Language), and any combination or derivative of one or more of these and/or others now known and/or later developed and/or discovered. To this extent, power system operation program 420 can be embodied as any combination of system software and/or application software.

Further, power system operation program 420 can be implemented using a set of modules 422. In this case, a module 422 can enable computer system 410 to perform a set of tasks used by power system operation program 420, and can be separately developed and/or implemented apart from other portions of power system operation program 420. As used herein, the term “component” means any configuration of hardware, with or without software, which implements the functionality described in conjunction therewith using any solution, while the term “module” means program code that enables a computer system 410 to implement the actions described in conjunction therewith using any solution. When fixed in a storage component 416 of a computer system 410 that includes a processing component 412, a module is a substantial portion of a component that implements the actions. Regardless, it is understood that two or more components, modules, and/or systems can share some/all of their respective hardware and/or software. Further, it is understood that some of the functionality discussed herein may not be implemented or additional functionality may be included as part of computer system 410.

When computer system 410 comprises multiple computing devices, each computing device can have only a portion of power system operation program 420 fixed thereon (e.g., one or more modules 422). However, it is understood that computer system 410 and power system operation program 420 are only representative of various possible equivalent computer systems that can perform a process described herein. To this extent, in other embodiments, the functionality provided by computer system 410 and power system operation program 420 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 410 includes multiple computing devices, the computing devices can communicate over any type of communications link. Further, while performing a process described herein, computer system 410 can communicate with one or more other computer systems using any type of communications link. In either case, the communications link can comprise any combination of various types of wired and/or wireless links; comprise any combination of one or more types of networks; and/or utilize any combination of various types of transmission techniques and protocols now known and/or later developed and/or discovered.

As discussed herein, power system operation program 420 enables computer system 410 to implement a power system operation product and/or method, such as that shown schematically in FIG. 2. Computer system 410 can obtain power system operation data 418 using any solution. For example, computer system 410 can generate and/or be used to generate power system operation data 418, retrieve power system operation data 418 from one or more data stores, and/or receive power system operation data 418 from another system or device, such as one or more sensors, in or outside of a power system and/or the like.

In another embodiment, the invention provides a method of providing a copy of program code, such as power system operation program 420 (FIG. 4), which implements some or all of a process described herein, such as that shown schematically in and described with reference to FIG. 2. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one tangible, non-transitory computer readable medium. In either case, the set of data signals can be transmitted/received using any type of communications link.

In still another embodiment, the invention provides a method of generating a system for implementing a power system operation product and/or method. In this case, a computer system, such as computer system 410 (FIG. 4), can be obtained (e.g., created, maintained, made available, etc.), and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A bidirectional power system comprising:
at least one power source configured to provide direct current (DC) power at a first DC voltage, and including at least one energy storage device configured to provide and receive the DC power at the first DC voltage;
a converter configured to be coupled to the at least one power source to convert and transfer power between the at least one power source at the first DC voltage and a bus at a second DC voltage that is greater than the first DC voltage;
an inverter configured to be coupled to the bus and configured to convert and transfer power between the bus at the second DC voltage and at least one of an electrical distribution network or a load at a first alternating current (AC) voltage; and
a control system coupled to the at least one power source, to the converter, and to the inverter, the control system being configured to provide power to the load, to transfer power in a first direction from the at least one power source to at least one of the load or the electrical distribution network, and to transfer power in a second direction from the electrical distribution network to the at least one energy storage device to maintain a defined amount of stored power in the at least one energy storage device.

2. The power system of claim 1, further comprising an islanding detector in communication with the control system and at least one of the power system or the electrical distribution network, and configured to send an islanding signal to the control system when an islanding condition is detected in at least one of the power system or the electrical distribution network.

3. The power system of claim 2, wherein the islanding detector monitors a voltage of the electrical distribution network and the islanding event includes the voltage deviating from a target operating voltage by a determined amount.

4. The power system of claim 2, wherein the islanding detector monitors a frequency of the electrical distribution network and the islanding event includes the frequency deviating from a target operating frequency by a determined amount.

5. The power system of claim 2, wherein, responsive to the islanding signal and a load being connected to the system, the control system provides power to the load from the at least one power source.

6. The power system of claim 2, wherein, responsive to the islanding signal, the control system disconnects the power system from the electrical distribution network.

7. The power system of claim 1, wherein, responsive to an amount of power supplied by the at least one power source exceeding a demand on the power system, the control system provides power to the electrical distribution network from the at least one power source.

8. The power system of claim 1, wherein the control system monitors at least one of the first DC voltage, the second DC voltage, or the first AC voltage.

9. The power system of claim 1, wherein the control system is configured to monitor a status of the at least one energy storage device, the status including an indication of an amount of power stored in the at least one energy storage device, and to draw power from the electrical distribution network when the amount of power stored is less than a defined amount of stored power to maintain at least the determined amount of stored power in the at least one energy storage device.

10. The power system of claim 1, wherein the at least one energy storage device includes a battery.

11. The power system of claim 1, wherein the at least one energy storage device includes a mechanical energy storage device.

12. A method comprising:
providing power in a first direction from a power source including at least one energy storage device to an electrical distribution network responsive to an amount of power available from the power source exceeding a demand on the power system;
drawing power in a second direction from the electrical distribution network to power a first AC load;
drawing power in the second direction from the electrical distribution network to maintain at least a determined amount of power in the at least one energy storage device; and
monitoring for an islanding condition in at least one of the power system or the electrical distribution network.

13. The method of claim 12, further comprising responding to an islanding condition by maintaining power to the first AC load, including drawing power in the first direction from the power source responsive to the demand on the power system.

14. The method of claim 13, wherein the maintaining power to the first AC load includes drawing power in the first direction from the power source until a supply of power from the power source reaches a defined threshold level.

15. The method of claim 12, further comprising shutting down at least one of a converter of the power system or an inverter of the power system responsive to an islanding condition.

16. The method of claim 12, further comprising decoupling the power system from the electrical distribution network responsive to an islanding condition.

17. A controller configured for:
providing power in a first direction from a power source to an electrical distribution network responsive to an amount of power available from the power source at least equaling a demand on the power system;
providing power in a second direction from the electrical distribution network to at least one energy storage device of the power source to maintain at least a determined amount of stored power in one or more of the at least one energy storage device; and
monitoring for an islanding condition in at least one of the power system or the electrical distribution network.

18. The controller of claim 17, further comprising responding to an islanding condition in at least one of the power system or the electrical distribution network by providing power in the first direction from the power source to a first AC load coupled to the power system.

19. The controller of claim 17, further comprising initiating an islanding condition responsive to a determined condition.

20. The controller of claim 17, further comprising responding to an islanding condition in at least one of the power system or the electrical distribution network by disconnecting the power system from the electrical distribution network.
